(19) United States
(12) Patent Application Publication
(10) Pub. No.: US 2023/0080023 A1
(43) Pub. Date: Mar. 16, 2023

(54) MULTI-MODE RESONATOR FOR QUANTUM COMPUTING ELEMENT

(71) Applicant: Samsung Electronics Co., Ltd., Suwon-si (KR)

(72) Inventors: Taehwan JANG, Suwon-si (KR); Hyeokshin KWON, Seoul (KR); Jaeho SHIN, Suwon-si (KR)

(73) Assignee: Samsung Electronics Co., Ltd., Suwon-si (KR)

(21) Appl. No.: 17/897,727

(22) Filed: Aug. 29, 2022

(30) Foreign Application Priority Data
Sep. 13, 2021 (KR) 10-2021-0122085
Oct. 21, 2021 (KR) 10-2021-0141370
Feb. 24, 2022 (KR) 10-2022-0024578

(51) Int. Cl. H01P 7/06; H01Q 1/22; G06N 10/40

(52) U.S. Cl. CPC H01P 7/06; H01Q 1/2208; G06N 10/40

(57) ABSTRACT

A multi-mode resonator for a quantum computing element is included. In one general aspect, an apparatus including a multi-mode electromagnetic resonator includes a structure configured with a cavity therein that extends lengthwise in a first direction, the cavity including a first side surface and a second side surface facing each other, iris regions are at positions along the first direction on the first side surface of the cavity, the iris regions are arranged to overlap respective electromagnetic fields that form in the cavity in a target mode when electromagnetic energy is supplied to the cavity.

### CROSS-REFERENCE TO RELATED APPLICATIONS

This application is based on and claims priority under 35 U.S.C. § 119 to Korean Patent Application Nos. 10-2021-0122085, 10-2021-0141370, and 10-2022-0024578, filed on Sep. 13, 2021, Oct. 21, 2021, and Feb. 24, 2022, in the Korean Intellectual Property Office, the disclosures of which are incorporated by reference herein in their entireties.

### BACKGROUND

### 1. Field

The present disclosure relates to a multi-mode resonator for a quantum computing element.

### 2. Description of the Related Art

Quantum computers may implement computing mechanisms using quantum mechanical phenomena such as quantum superposition and quantum entanglement as operation principles to perform data processing such as testing conditions and storing information. A fundamental element capable of storing information by using quantum mechanical principles is referred to as a quantum bit or a qbit, which may be used as a basic computing element of quantum computers. The term “qbit” may also refer to the information stored by a qbit computing element.

The bit used in classical data storage devices has a state of “0” or “1,” whereas a qbit may have both states of “0” and “1” simultaneously due to the superposition phenomenon. Further, due to the quantum entanglement phenomenon, there may be interactions between qbits. According to such characteristics of qbits, in some implementations, N qbits may theoretically store up to 2N bits of information. As a result, when the number of qbits increases, the amount of information and information processing speed may increase in an exponential manner.

Various methods of implementing qbits for quantum computers have been researched. Among the methods, qbits using superconductors have shown promise for use in manufactured integrated circuits.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an apparatus including a multi-mode electromagnetic resonator includes a structure configured with a cavity therein that extends lengthwise in a first direction, the cavity including a first side surface and a second side surface facing each other, iris regions are at positions along the first direction on the first side surface of the cavity, the iris regions are arranged to overlap respective electromagnetic fields that form in the cavity in a target mode when electromagnetic energy is supplied to the cavity.

The iris regions may overlap respective centers of the respective electromagnetic fields when electromagnetic energy is supplied to the cavity.

Distances between at least some neighboring iris regions may increase in the first direction.

The first side surface of the cavity may have concave structures.

The first side surface of the cavity may have convex parts, and each iris region may be arranged, on the first side surface between a corresponding pair of the convex parts.

The first side surface of the cavity may have concave parts, and each iris region may be arranged, on the first side surface, between a corresponding pair of the concave parts.

The cavity may have a shape that may be a part of a figure determined by

x=(Lc+Loffset)×sin(t)^{order}, z=w_{CM}/2×cos(t), where Lc may be less than half the maximum length of the figure on an x-axis as determined by the equation, where Loffset may be a length difference between Lc and half the maximum length of the figure on the x-axis, and where WCM may be a maximum width of the cavity on a z-axis.

The iris regions may have a same width.

The structure may include a housing that may further include the cavity and the iris regions, and the cavity and the iris regions may be defined by the housing.

The cavity may be a storage cavity, and the multi-mode resonator may be the storage cavity and a reader cavity for a quantum computing apparatus.

The apparatus may be a computing apparatus and may further include a qbit element, an antenna coupled with the qbit element, and at least a portion of the antenna may be within the cavity.

In one general aspect, a quantum computing apparatus includes a qbit element, a storage cavity and a reader cavity within a housing or within respective housings, a storage antenna is configured to be electrically connected to the qbit element and at least partly within the storage cavity, a reader antenna is configured to be electrically connected to the qbit element and at least partly within the reader cavity, the storage cavity extends lengthwise in a first direction and may include iris regions arranged at positions along the first direction on a first side surface of the storage cavity, and the positions of the iris regions are arranged to overlap respective electromagnetic fields that form in the storage cavity in a target mode when electromagnetic energy is supplied to the storage cavity.

The iris regions may be arranged to overlap respective centers of the electromagnetic fields.

Distances between at least some neighboring iris regions may increase in the first direction.

A surface of the storage cavity may have a concave structure.

The first side surface of the storage cavity may have convex parts, and each iris region may be positioned between a corresponding pair of the convex parts.

The first side surface of the storage cavity may have concave parts, and each iris region may be positioned between a corresponding pair of the concave parts.

A width of the storage cavity may taper in the first direction.

The iris regions may have a same width.

The iris regions may be part of the housing or one of the housings, and the storage cavity and the iris regions may be defined by the housing or the one of the housings.

The iris structures may be respective protrusions of, or recessions within, the housing.

Areas of the first surface between the recessions or protrusions comprise convex or concave structures that may be parallel to the iris structures.

Other features and aspects will be apparent from the following detailed description, the drawings, and the claims.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a perspective view of a multi-mode resonator, according to one or more embodiments.

FIG. 2 is a perspective view of a first storage cavity, according to one or more embodiments.

FIG. 3 is a side view of the first storage cavity, according to one or more embodiments.

FIG. 4 is an enlarged view of a region of the first storage cavity, according to one or more embodiments.

FIG. 5 is a top view of the first storage cavity, according to one or more embodiments.

FIG. 6 is a top view of a shape of the first storage cavity, according to one or more embodiments.

FIG. 7 is a top view of an arrangement relationship between electromagnetic fields and first iris regions formed in the first storage cavity, according to one or more embodiments.

FIG. 8 is a transfer function graph illustrating storage modes occurring in the first storage cavity when the first storage cavity does not include first iris regions, according to one or more embodiments.

FIG. 9 is a transfer function graph illustrating a mode occurring in a first storage cavity that includes first iris regions, according to one or more embodiments.

FIG. 10 is a perspective view of a multi-mode resonator, according to one or more embodiments.

FIG. 11 is a perspective view of a second storage cavity, according to one or more embodiments.

FIG. 12 is a side view of the second storage cavity, according to one or more embodiments.

FIG. 13 is an enlarged view of a region of the second storage cavity, according to one or more embodiments.;

FIG. 14 is a perspective view of a multi-mode resonator according to one or more embodiments.

FIG. 15 is a perspective view of a third storage cavity, according to one or more embodiments.

FIG. 16 is a side view of the third storage cavity, according to one or more embodiments.

FIG. 17 is an enlarged view of a region of the third storage cavity, according to one or more embodiments.

FIG. 18 is a perspective view of a multi-mode resonator, according to one or more embodiments.

FIG. 19 is a perspective view of a fourth storage cavity, according to one or more embodiments.

FIG. 20 is a side view of the fourth storage cavity, according to one or more embodiments.

FIG. 21 is an enlarged view of a region of the fourth storage cavity, according to one or more embodiments.

FIG. 22 is a perspective view of a quantum computing element, according to one or more embodiments.

FIG. 23 is a cross-sectional view of a qbit chip, according to one or more embodiments.

Throughout the drawings and the detailed description, unless otherwise described or provided, the same drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

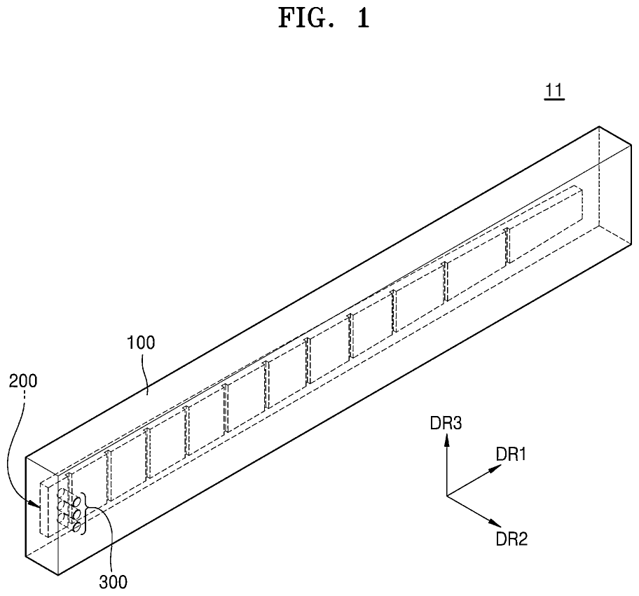

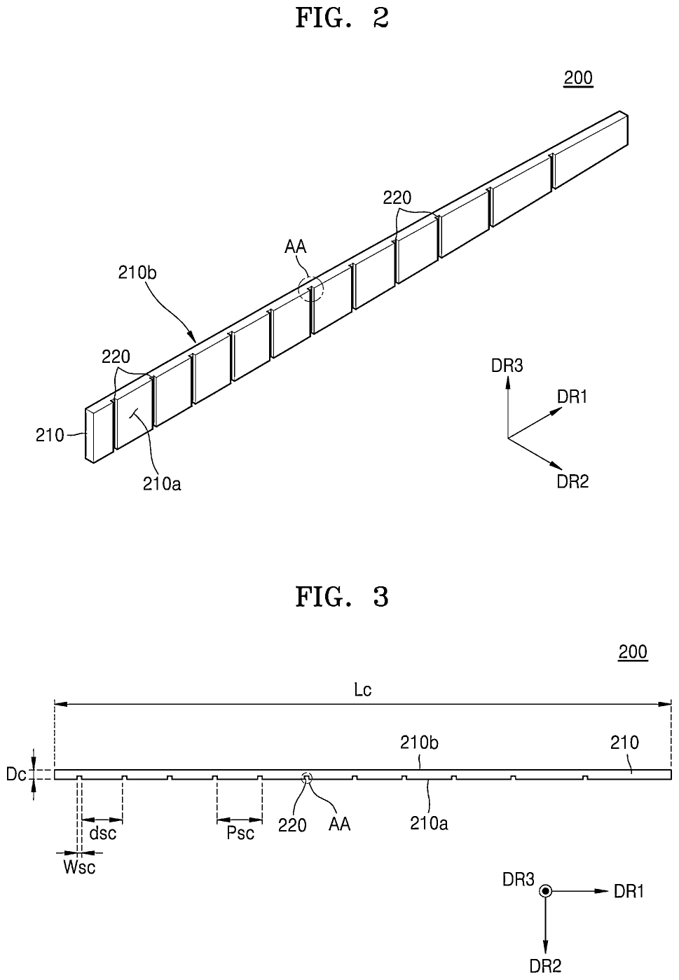

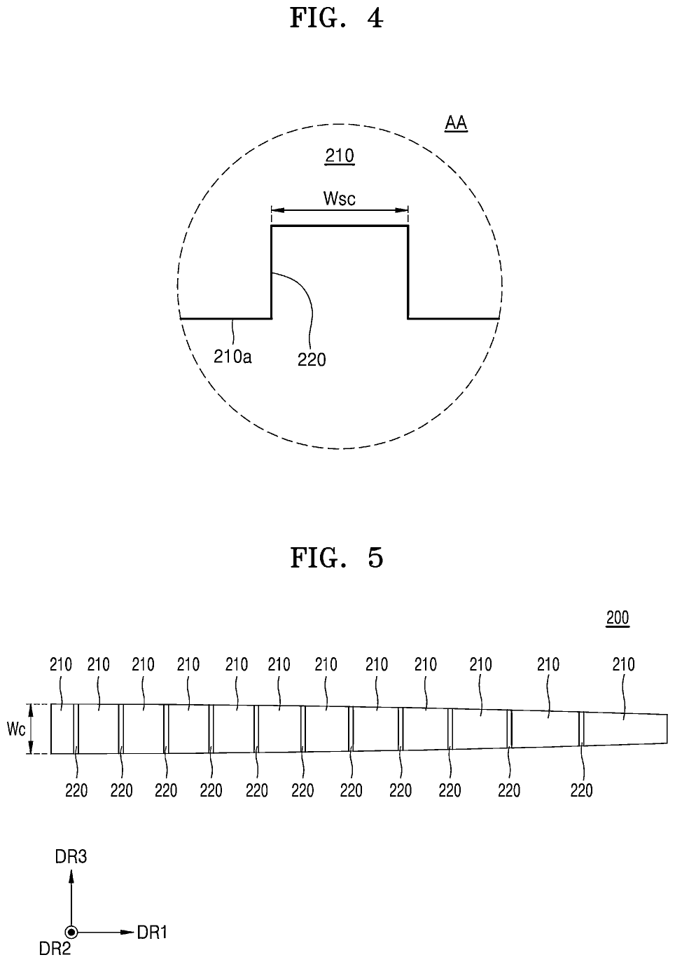

FIG. 1 is a perspective view of a multi-mode resonator 11, according to one or more embodiments. FIG. 2 is a perspective view of a first storage cavity 200 shown in FIG. 1. FIG. 3 is a side view of the first storage cavity 200. FIG. 4 is an enlarged view of a region AA in FIG. 3. FIG. 5 is a top view of the first storage cavity 200.

Referring to FIGS. 1 to 5, the multi-mode resonator 11 may include a housing 100, the first storage cavity 200, and ports 300. The housing 100 may prevent electromagnetic signal inflow from the outside of the housing 100 into the inside, i.e., may provide electromagnetic shielding. The housing 100 may include superconducting materials. For example, the housing 100 may include aluminum (Al), niobium (Nb), indium (In), or combinations thereof (such materials may become superconductive when lowered to sufficiently low temperature). The housing 100 may be a single structure or a seamless structure which does not have a boundary surface therein. In other words, in some embodiments, the housing 100 may be formed by processing one structure rather than combining two or more structures, e.g., by excavation, molded casting, or the like. In some embodiments, electromagnetic shielding may be provided by a separate layer, e.g., an electroplated metal on the surface of the housing 100. In some embodiments, the housing 100 may be formed from multiple structures fitted together.

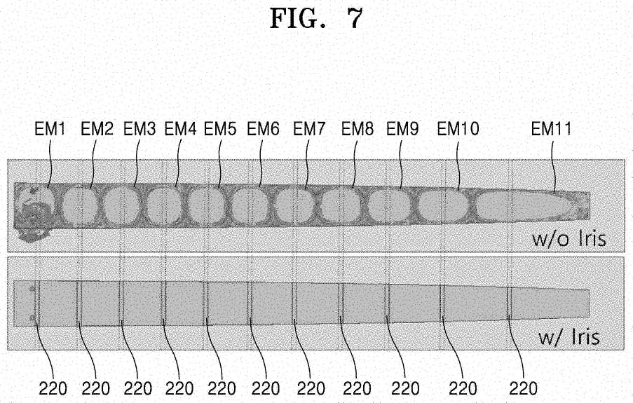

The first storage cavity 200 may be provided in the housing 100. The first storage cavity 200 may be an element for performing a unitary operation in conjunction with a qbit and, in some embodiments may increase a coherence-state duration of the qbit. The first storage cavity 200 may be defined as a space within the housing 100. The first storage cavity 200 may provide a region where electromagnetic energy resonates to form distinct electromagnetic fields along the length of the first storage cavity 200 (see, e.g., FIG. 7). The first storage cavity 200 may have a length extending in a first direction DR1. The length of the first storage cavity 200 is referred to as a cavity length Lc. The cavity length Lc may be determined as needed. The first storage cavity 200 may have a thickness extending in a second direction DR2 which intersects the first direction DR1 and is normal to, and a distance between, first side surface 210a and second side surface 210b. The thickness of the first storage cavity 200 is referred to as a cavity thickness Dc. The first storage cavity 200 may have a width extending in a third direction DR3 which intersects the first direction DR1 and the second direction DR2. For example, the first direction DR1, the second direction DR2, and the third direction DR3 may each be perpendicular to the others. The width of the first storage cavity 200 may be referred to as a cavity width Wc. The cavity width Wc may decrease in the first direction DR1. The shape of the first storage cavity 200, in particular an overhead profile thereof, will be described below from a viewpoint distant from the first storage cavity 200 along the second direction DR2 (i.e., a top view).

The first storage cavity 200 may include a first main cavity 210 and first iris regions 220. The first main cavity 210 may extend in the first direction DR1. The first main cavity 210 may include the first side surface 210a (which may be planar) and the second side surface 210b (which may also be planar) extending in the first direction DR1. The first side surface 210a and the second side surface 210b may be disposed opposite and parallel to each other in the second direction DR2, and may be parallel to directions DR1 and DR3 and normal to direction DR2. The first side surface 210a may have concave parts. Here, “concave” means recessed and does not imply curved, although curved parts may be used.

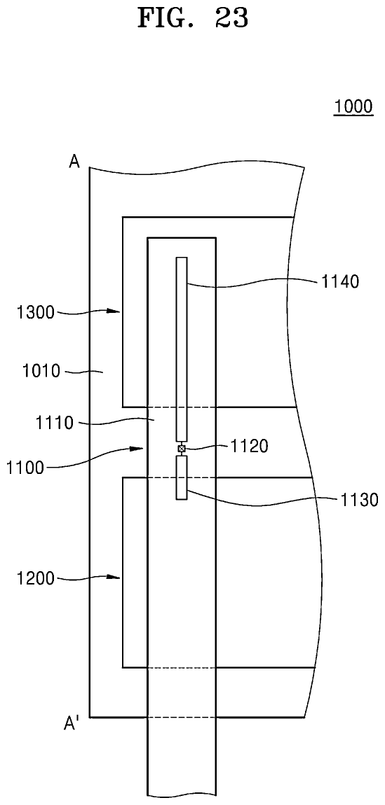

The first iris regions 220 may be provided on, and extend from, the first side surface 210a of the first main cavity 210. The first iris regions 220 may be defined by, or may separate, concave parts of the first side surface 210a. For example, the first iris regions 220 may be regions dividing concave parts of the first side surface 210a. The first iris regions 220 may be formed by respective portions of the housing 100. The first iris regions 220 may be arranged along the length of the first main cavity 210 in the first direction DR1. As described below with reference to FIG. 7, the first iris regions 220 may be arranged to respectively overlap electromagnetic fields generated in the first storage cavity 200 in a target mode. The target mode may be a mode in which generation in the first main cavity 210 is suppressed. Positional relationships between the first iris regions 220 suitable to be used by a reader cavity (see FIGS. 22 and 23) and the electromagnetic fields are described below.

The distances between adjacent first iris regions 220 is referred to as iris distance dsc. In addition to the first iris regions, examples described below include second iris regions, third iris regions, and fourth iris regions. The distances between adjacent second iris regions, between adjacent third iris regions, and between adjacent fourth iris regions, are also referred to as the iris distance dsc. The iris distances dsc between adjacent first iris regions 220 may increase in the first direction DR1. The first iris regions 220 may have widths in the first direction DR1. For example, the first iris regions 220 may have substantially the same widths (all distances and shapes described herein may vary within tolerances determinable by performance of quantum computing operations). Each width of the first iris regions 220 may be referred to as an iris width Wsc. The widths of the second to fourth iris regions, described below, are also referred to as the iris width Wsc. The sum of an iris width Wsc and an adjoining iris distance dsc may be referred to as an iris pitch Psc, as shown in FIG. 3.

The ports 300 may be provided in the housing 100. The ports 300 may be holes through the housing 100. Exterior ends of the plurality of ports 300 may be openings on the outside of the housing 100, and interior ends may be openings in a surface of the first storage cavity 200. For example, the ends of the ports 300 may be disposed at either or both ends of the first storage cavity 200 with respect to the first direction DR1. The ports 300 may be regions into which an element inputting a high-frequency signal to the multi-mode resonator 11 or outputting a high-frequency signal from the multi-mode resonator 11 is inserted (see FIGS. 22 and 23). In some embodiments, three ports 300 are provided, but this is not limiting. The number of ports 300 may be determined as necessary.

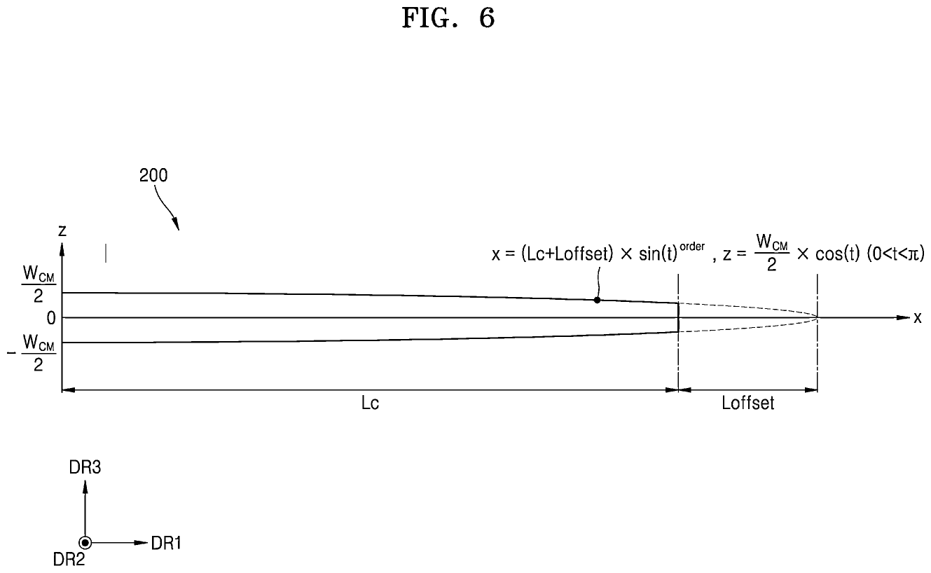

FIG. 6 is a top view of a profile shape of the first storage cavity 200 of FIG. 1, according to one or more embodiments.

Referring to FIG. 6, the shape of the first storage cavity 200 is illustrated from a viewpoint along the second direction DR2 and away from the first storage cavity 200. The shape of the first storage cavity 200 from the viewpoint along the second direction DR2 may be substantially the same as the shape of the first main cavity 210 from the viewpoint along the second direction DR2. Accordingly, the following description of the shape of the first storage cavity 200 may be substantially the same as the description of the shape of the first main cavity 210. The shape of the first storage cavity 200 is illustrated by a solid line (excluding the x axis). From the viewpoint along the second direction DR2, the shape of the first storage cavity 200 may be a part of a figure determined by the following equation (an excluded part of the figure, including an inflection point, is shown with dashes). The figure determined by the following equation may have an elliptical shape.

$$x = ( Lc + Loffset ) \times {sin ( t )}^{order} , z = \frac{{w}_{CM}}{2} \times cos ( t ) \qquad Equation 1$$

The origin (represented by 0) at which the x-axis and the z-axis intersect shown in FIG. 6 may be an intersection point of a side surface of the first storage cavity 200 facing the opposite direction to the first direction DR1 and a center line of a width of the first storage cavity 200. Lc may denote a length of the first storage cavity 200 in the first direction DR1. The figure expressed by Equation 1 has symmetry with respect to the z axis, and thus Lc may be less than half of the maximum length on the x-axis of the figure (a half of the figure to the left of the z axis is not shown), which corresponds to the first storage cavity 200. Loffset may denote the length of the remaining part of the figure determined by Equation 1, denoted by dashes. In other words, Loffset may be a length obtained by subtracting Lc from half of the maximum length of the figure determined by Equation 1 on the x-axis. W_{CM} may denote the maximum width of the first storage cavity 200 (i.e., the maximum value of the cavity width Wc). That is, W_{CM} may be the maximum width of the first storage cavity 200 on the z-axis.

When the shape of the first storage cavity 200 from the viewpoint along the second direction DR2 has a parabola rather than an ellipse, it may be less convenient to manufacture the shape because the end has a pointed shape at a lower order, it may be difficult to optimize performance because a distance between modes (storage modes, described below) is changed according to the order, and may be difficult to implement monotonically increasing characteristics with respect to all modes. Nonetheless, various profile shapes, including a parabolic shape, may be used with varying results.

When the first storage cavity 200 seen from the second direction DR2 has an ellipse shape, it may be convenient to manufacture the storage cavity 200 because the end of the first cavity 200 has a round shape, the distance between the modes may be constant, and a monotonically increasing characteristic may be implemented with respect to the storage modes.

Other storage cavities described herein may have a general top-view profile shape that is the same as, or similar to, the figure described with reference to FIG. 6. That is, other storage cavities described herein may have a top-view profile shape the same as, or similar to, that of the first cavity 200.

FIG. 7 is a top view of an arrangement relationship between electromagnetic fields EM1 to EM11 and the first iris regions 220 formed in the first storage cavity 200 of FIG. 1, according to one or more embodiments.

Referring to FIG. 7, the electromagnetic fields EM1 to EM11 are first formed in a storage cavity that does not include the first iris regions 220 in a target mode (the upper storage cavity labeled as “w/o Iris”). The electromagnetic fields EM1 to EM11 may be formed by of resonation, within the storage cavity, of electromagnetic energy supplied to the storage cavity, for example from an antenna. The number of electromagnetic fields EM1 to EM11 may be determined according to the target mode. The first iris regions 220 are arranged in a version of the storage cavity (the storage cavity labeled as “w/Iris”) according to the observed electromagnetic fields. Specifically, from a viewpoint along the second direction DR2, the first iris regions 220 may be respectively arranged at positions respectively based on where the electromagnetic fields EM1 to EM11 are generated in the target mode without the first iris regions 220. For example, from the viewpoint along the second direction DR2, the first iris regions 220 may be arranged to respectively overlap (or be near) the centers of the electromagnetic fields EM1 to EM11 generated in the target mode in a version of the cavity that does not have the first iris regions 220.

In some embodiments, the electromagnetic fields EM1 to EM11, for example, may be simulated by a computer that models the corresponding storage cavity.

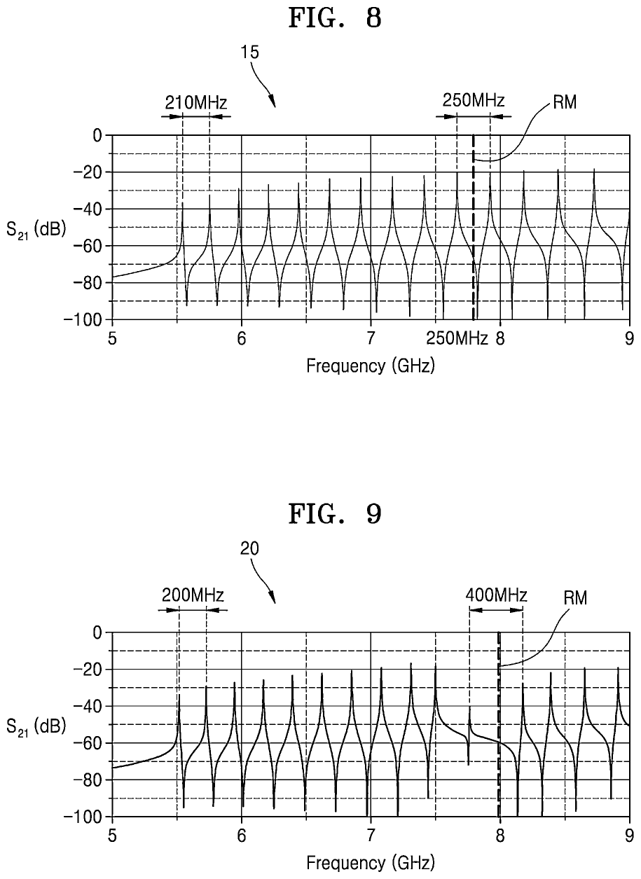

FIG. 8 is a transfer function graph 15 illustrating storage modes occurring in a version of the first storage cavity of FIG. 1 that does not include the first iris regions. FIG. 9 is a transfer function graph 20 illustrating a mode occurring in a version of the first storage cavity of FIG. 1 that includes the first iris regions.

Referring to FIG. 8, the storage modes occurring in the version of the first storage cavity that does not include the first iris regions may occur at similar frequency distances. The frequency distance between the storage modes may be between about 210 MHz and about 250 MHz. The storage modes are modes generated in the storage cavity (i.e., resonant frequencies of the first storage cavity, as indicated by the peaks in graph 15). A reader mode (indicated by “RM” in FIG. 8) is disposed between a 10th storage mode and an 11th storage mode. The reader mode is a mode occurring in a reader cavity (that is, a resonant frequency of the reader cavity), which is described below with reference to FIGS. 22 and 23. The storage modes and the reader mode should be spaced apart by more than a certain frequency distance (hereinafter, the minimum distance) in consideration of qbit-cavity coupling, signal bandwidth, thermal noise, and various interferences. As shown in FIGS. 8 and 9, the minimum distance may be about 200 MHz. When the storage mode and the reader mode are extremely close together, an error rate of a quantum computing element may increase. A certain frequency lower than the storage modes may be used as an operating frequency (not shown) of the qbit.

The greater the number of storage modes that may be arranged between the operating frequency of the qbit and the reader mode, the higher the quantum information storage density within an available frequency spectrum. When the storage modes are uniformly arranged to be spaced apart by the minimum distance, the number of the storage modes arranged between the operating frequency of the reader qbit and the reader mode may be maximum. As shown in FIG. 8, when the reader mode is disposed between the storage modes, the storage modes may be spaced apart by the minimum distance, but the reader mode and the storage mode may be closer than the minimum distance.

Referring to FIG. 9, the storage modes occurring in the version of the first storage cavity that includes the first iris regions occur at similar distances, but generation of a target mode is suppressed. The distance between the storage modes is about 200 MHz, but the distance between an 11th storage mode and a 12th storage mode is about 400 MHz. That is, the generation of the 12^{th} storage mode, which would have occurred in the absence of the iris regions, is suppressed by the iris regions. The reader mode may be disposed at a frequency spaced apart from the 11th storage mode and the 12th storage mode by about 200 MHz (the minimum distance) to each storage mode. The frequency distances between the storage modes and between the storage modes and the reader mode may be spaced (possibly somewhat uniformly) by the minimum distance. Accordingly, the number of storage modes disposed between the operating frequency of the reader qbit and the frequency of the reader mode may be increased, and the quantum information storage density within the available frequency spectrum may be increased.

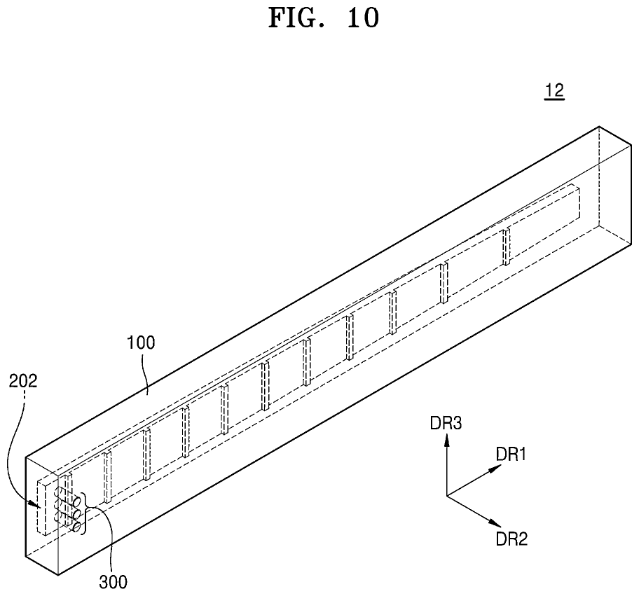

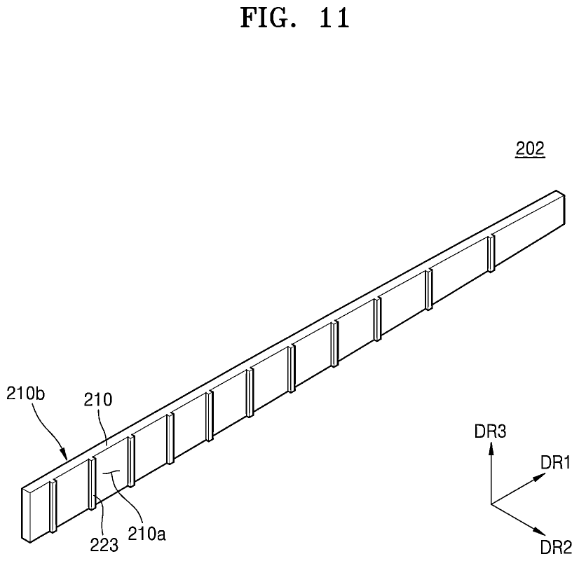

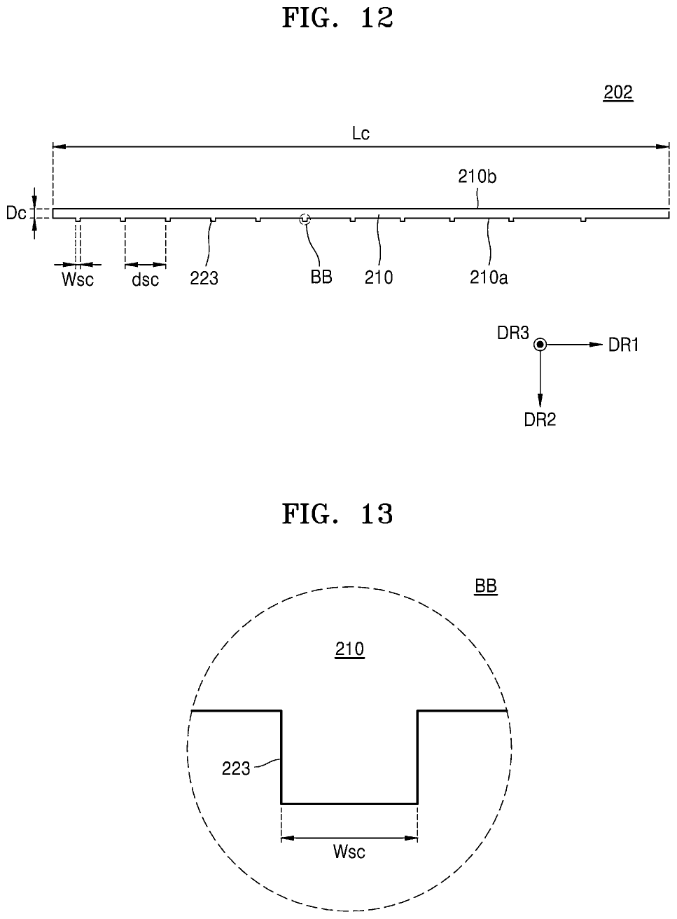

FIG. 10 is a perspective view of a multi-mode resonator 12 according to one or more embodiments. FIG. 11 is a perspective view of a second storage cavity 202 of the multi-mode resonator 12 shown in FIG. 10. FIG. 12 is a side view of the second storage cavity 202 shown in FIGS. 10 and 11. FIG. 13 is an enlarged view of the region BB indicated in FIG. 12. Descriptions of elements and features substantially the same as those described with reference to FIGS. 1 to 5 may be applicable and are therefore omitted.

Referring to FIGS. 10 to 13, the multi-mode resonator 12 may include the housing 100, the second storage cavity 202, and the ports 300. The housing 100 and the ports 300 may be substantially the same as the housing 100 and the ports 300 described with reference to FIGS. 1 to 5.

The second storage cavity 202 may include the first main cavity 210 and second iris regions 223. The first main cavity 210 may extend in the first direction DR1. The first main cavity 210 may include the first side surface 210a and the second side surface 210b extending in the first direction DR1. The first side surface 210a and the second side surface 210b may be disposed opposite to each other in the second direction DR2 and may face each other. The first side surface 210a may have convex parts.

The second iris regions 223 may be provided as protrusions from the first side surface 210a of the first main cavity 210. The second iris regions 223 may be defined by (or may define) convex parts of the first side surface 210a. For example, the second iris regions 223 may be regions surrounded by convex parts of the first side surface 210a. The second iris regions 223 may be filled by a part of the first main cavity 210. The second iris regions 223 may be arranged along the length of the main cavity 210 in the first direction DR1. The second iris regions 223 may be arranged to respectively overlap electromagnetic fields generated in the second storage cavity 202 in a target mode.

The iris distance dsc and the iris width Wsc of the second iris regions 223 may be respectively the same as the iris distance dsc and the iris width Wsc of the first iris regions 220 described with reference to FIGS. 1 to 5.

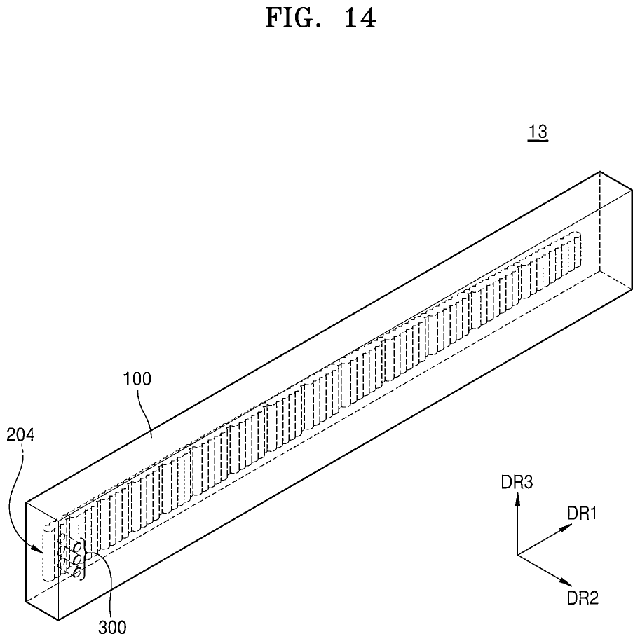

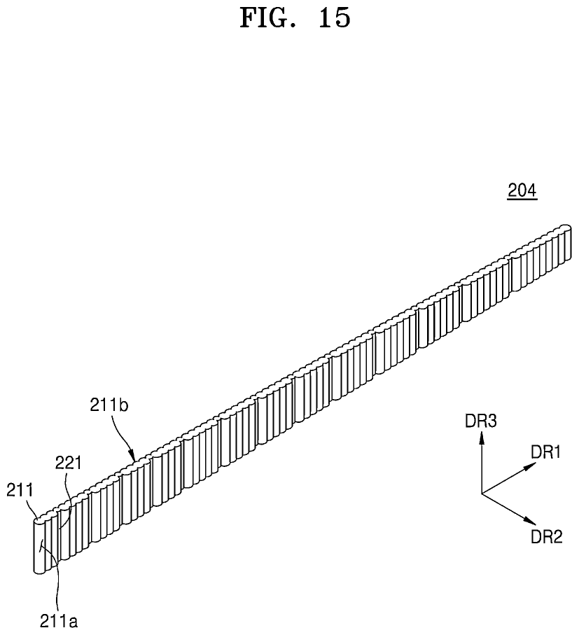

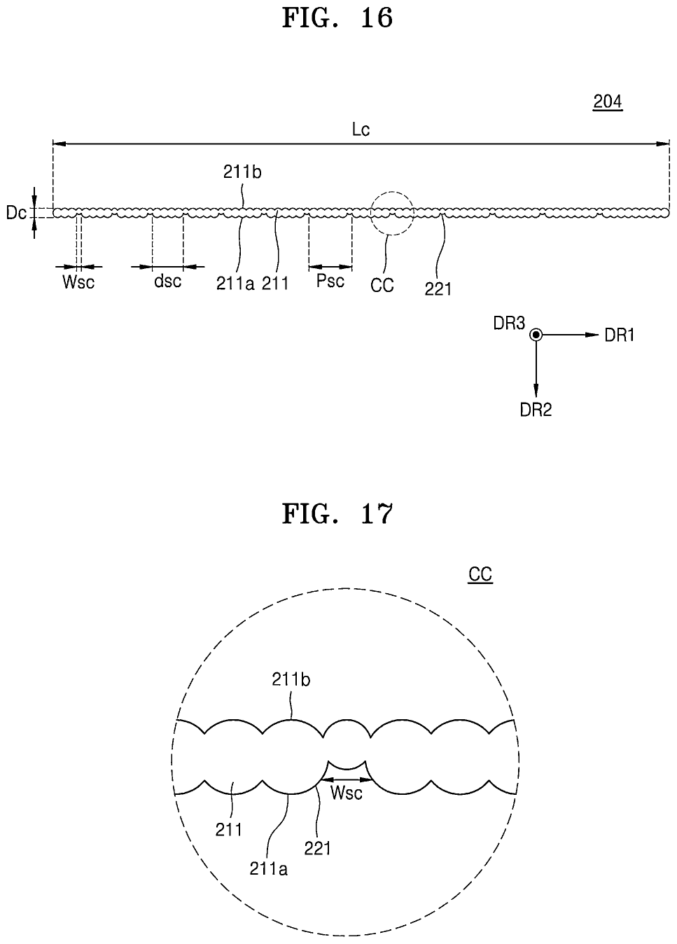

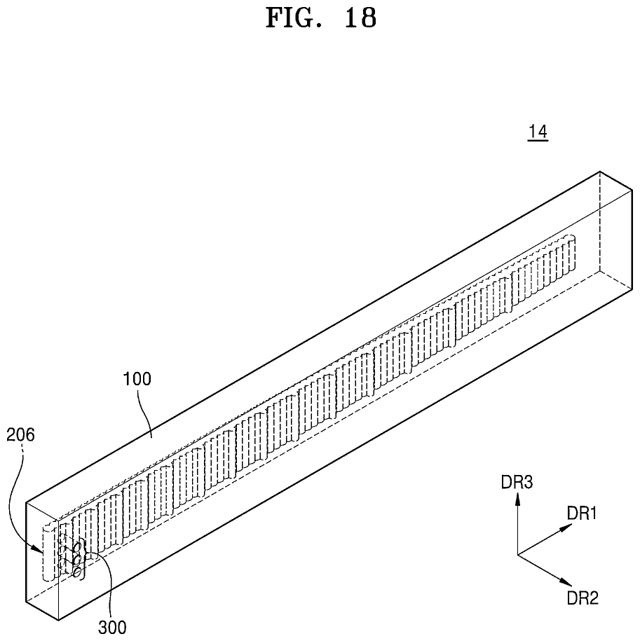

FIG. 14 is a perspective view of a multi-mode resonator 13, according to one or more embodiments. FIG. 15 is a perspective view of a third storage cavity 204 shown in FIG. 14. FIG. 16 is a side view of the third storage cavity. FIG. 17 is an enlarged view of a region CC shown in FIG. 16. Descriptions of features and elements substantially the same as those described with reference to FIGS. 1 to 5 may be applicable and are therefore omitted.

Referring to FIGS. 14 to 17, the multi-mode resonator 13 may include the housing 100, the third storage cavity 204, and the ports 300. The housing 100 and the ports 300 may be substantially the same as the housing 100 and the ports 300 described with reference to FIGS. 1 to 5.

The third storage cavity 204 may include a second main cavity 211 and third iris regions 221. As described with reference to FIGS. 1 to 5, the second main cavity 211 may extend lengthwise in the first direction DR1. Unlike the first main cavity 210 described with reference to FIGS. 1 to 5, first side surface 211a and second side surface 211b of the second main cavity 211 may include multiple concave structures between each pair of neighboring third iris regions 221 (here, “concave” is relative to the housing 100 and refers to a curved shape). As shown in FIG. 17, the third iris regions 221 may have concave faces (normal to second direction DR2) recessed in the housing 100. The concave structures may be arranged at respective positions in the first direction DR1. Columnar axes of the concave structures may extend in the third direction DR3. The concave structures may have a shape like a part of a circular column (e.g., parallel columns whose parallel region of intersection is omitted), but this is an example. In another example, the concave structures may have a shape like a part of the polygonal column (i.e., faceted sides with facets extending in the third direction DR3), as opposed to the smooth shapes shown in FIG. 15.

The third iris regions 221 may be provided on the first side surface 211a of the first main cavity 210. The third iris regions 221 may be defined by concave parts of the first side surface 211a (i.e., convex recessions within iris extensions of the housing 100). For example, the third iris regions 221 may be regions surrounded by concave parts of the first side surface 211a that are recessed into the housing 100 further than the third iris regions 221. Surfaces of the third iris regions 221 may have a concave structure similar to the concave parts of the first side surface 211a (and may be implemented with facets). The third iris regions 221 may be extensions/protrusions of the housing 100. The third iris regions 221 may be arranged at positions along the first direction DR1. The third iris regions 221 may be positioned along the length of the second main cavity 211 to respectively overlap electromagnetic fields generated in the first storage cavity 200 in a target mode.

The iris distance dsc and the iris width Wsc of the third iris regions 221 may be the same as the iris distance dsc and the iris width Wsc of the first iris regions 220 described with reference to FIGS. 1 to 5. However, because the surfaces of the third iris regions 221 are concave, the iris distance dsc and the iris width Wsc may be measured in intermediate positions of the third iris regions 221 in the second direction DR2 (see FIG. 17). In some embodiments, concave structures opposite from the respective third iris regions 221 may have widths close to the widths of the opposing third iris regions 221 (e.g., iris width Wsc). In some embodiments, opposing concavities may be angular sections of a same column, and the columns of the third iris regions 221 may have radii smaller than radii of the columns therebetween.

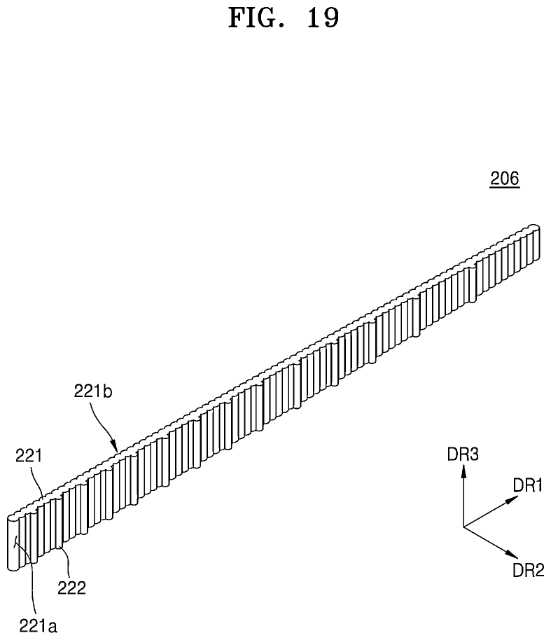

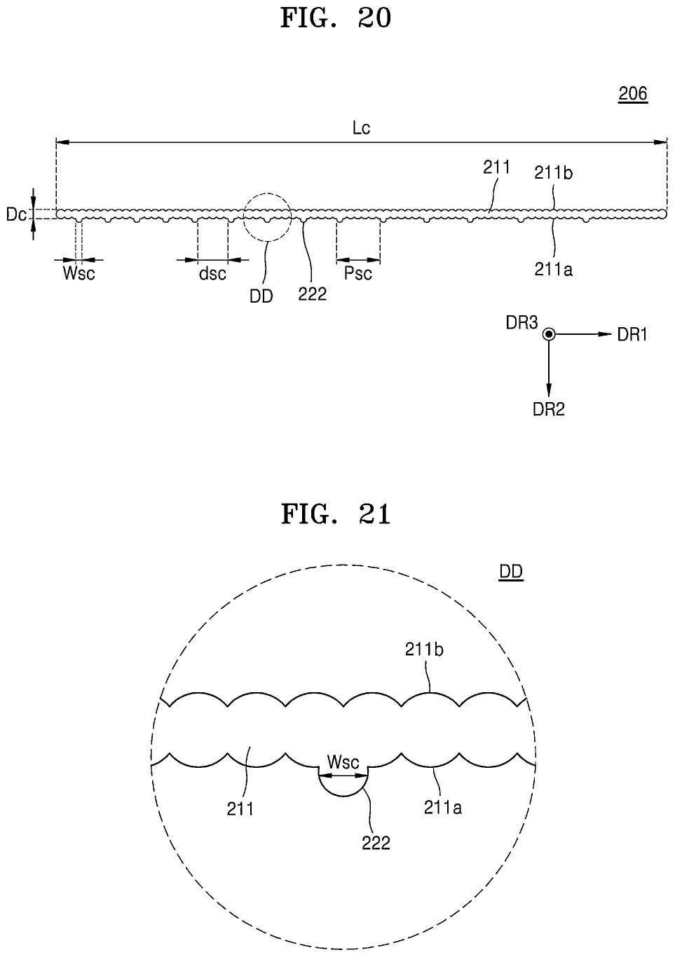

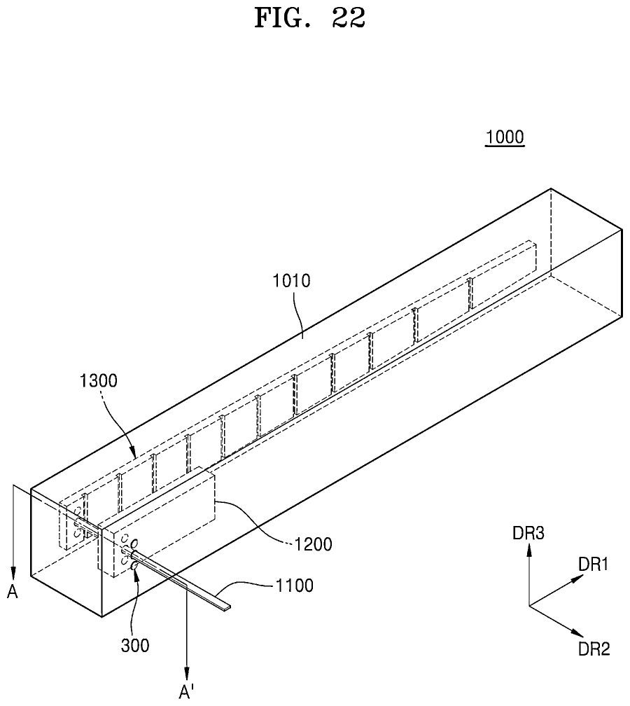

FIG. 18 is a perspective view of a multi-mode resonator 14, according to one or more embodiments. FIG. 19 is a perspective view of a fourth storage cavity 206 of the multi-mode resonator 14. FIG. 20 is a side view of the fourth storage cavity 206. FIG. 21 is an enlarged view of a region DD denoted in FIG. 18. Descriptions of elements and features substantially the same as those described with reference to FIGS. 10 to 13 may be applicable and are therefore omitted.

Referring to FIGS. 18 to 21, the multi-mode resonator 14 may include the housing 100, the fourth storage cavity 206, and the ports 300. The housing 100 and the plurality of ports 300 may be substantially the same as the housing 100 and the ports 300 described with reference to FIGS. 1 to 5.

The fourth storage cavity 206 may include the second main cavity 211 and fourth iris regions 222. The second main cavity 211 may extend lengthwise in the first direction DR1. Unlike the first main cavity 210 described with reference to FIGS. 10 to 13, the first side surface 211a and the second side surface 211b of the second main cavity 211 may include concave structures. The concave structures may be arranged along the length of the fourth storage cavity 206 in the first direction DR1. Axes of the concave structures may extend in the third direction DR3. The concave structures may have a shape like a part of a circular column (with a longitudinal section omitted), but this is an example. In another example, the concave structures may have a shape like a part of the polygonal column, i.e., they may have faceted faces rather than smoothly curved faces.

The fourth iris regions 222 may be provided on the first side surface 211a of the second main cavity 211. The fourth iris regions 222 may be defined by convex parts of the first side surface 211a. For example, the fourth iris regions 222 may be regions surrounded by convex parts of the first side surface 211a, where the fourth iris regions 222 are recessed in the housing 100 relative to the convex parts. The fourth iris regions 222 may be filled by a part of the second main cavity 211, i.e., recessed into the housing 100. In comparison to the iris regions discussed above, the fourth iris regions 222 may be similar in placement and structure, but inverted, i.e., they may be recessed within the housing rather than protrusions of the housing into the main cavity. The fourth iris regions 222 may be arranged at positions in the first direction DR1 along the length of the fourth storage cavity 206. The fourth iris regions 222 may be arranged to respectively overlap electromagnetic fields (e.g., centers thereof) generated in the second storage cavity 202 in a target mode.

The iris distance dsc and the iris width Wsc of the fourth iris regions 222 may be the same as the iris distance dsc and the iris width Wsc of the first iris regions 220 described with reference to FIGS. 1 to 5. However, because the surfaces of the fourth iris regions 222 have a concave structure, the iris distance dsc and the iris width Wsc may be measured relative to intermediate positions (as opposed to edges) of the fourth iris regions 222 in the second direction DR2.

FIG. 22 is a perspective view of a quantum computing element 1000, according to one or more embodiments. FIG. 23 is a cross-sectional top view of a qbit chip 1100 shown in FIG. 22. Descriptions of features and elements substantially the same as those described above with reference to FIGS. 1 to 5 may be applicable and are therefore omitted.

Referring to FIGS. 22 and 23, the quantum computing element 1000 may include the qbit chip 1100, a housing 1010, a reader cavity 1200, and a storage resonator 1300. The housing 1010 may be substantially the same as any of the housings described above, e.g., housing 100. The storage cavity 1300 may be substantially the same as the storage cavity 200 described with reference to FIGS. 1 and 5. However, the present disclosure is not limited thereto. The storage cavity 1300 may be any one of the other storage cavities described herein, e.g., the second, third, and fourth storage cavities 202, 204, and 206.

The qbit chip 1100 may include a substrate 1110, a qbit element 1120, a reader antenna 1130, and a storage antenna 1140. The substrate 1110 may include insulating materials. For example, the substrate 1110 may include a silicon substrate and/or a sapphire substrate.

The qbit element 1120 may be provided on the substrate 1110. The qbit element 1120 may be an element having a nonlinear coupling. For example, the qbit element 1120 may include a Josephson junction. The Josephson junction may include a pair of superconducting material layers facing each other and one or more non-superconducting layers (e.g., a dielectric layer) inserted between the pair of superconducting material layers. Alternatively, the Josephson junction may include a pair of superconducting material layers facing each other with an air gap between the pair of superconducting material layers. Cooper pairs may tunnel through a Josephson junction. A Cooper pair is an electron-pair which is free from electrical resistance in superconducting material patterns. Cooper pairs share the same quantum state and are typically represented by the same wave function.

The reader antenna 1130 may be arranged on the substrate 1110. The reader antenna 1130 may be arranged to one side of the qbit element 1120. The reader antenna 1130 may be capacitively coupled with a reader connector which may be arranged on the reader cavity 1200, for example. The reader connector may receive electronic signals from a device outside the quantum computing element, and convert the electronic signals into high frequency electromagnetic signals. The reader antenna 1130 may receive high frequency signals provided from the reader connector, and transmit high frequency signals to the reader connector. The reader antenna 1130 may include superconducting materials. For example, the reader antenna 1130 may include aluminum (Al), niobium (Nb), indium (In), or combinations thereof.

The storage antenna 1140 may be arranged on the substrate 1110. The storage antenna 1140 may be arranged to the side of the qbit element 1120 opposite the reader antenna 1130. The storage antenna 1140 may be capacitively coupled with a storage connector (not explicitly shown in the drawings) which may be arranged on the storage cavity 1300. The storage connector may receive electronic signals from a device outside the quantum computing element 1000, and convert (emit) the electronic signals into (as) high frequency electromagnetic signals. The storage antenna 1140 may receive high frequency signals provided from the storage connector, and may transmit high frequency signals to the storage connector, i.e., the storage connector and storage antenna 1140 may exchange high frequency signals. The storage antenna 1140 may increase coherence state duration of the qbit element 1120 and may be arranged in the storage cavity 1300 to perform unitary operations. The storage antenna 1140 may include superconducting materials. For example, the storage antenna 1140 may include aluminum (Al), niobium (Nb), indium (In), or combinations thereof.

The reader antenna 1130 may fully or partly extend into the reader cavity 1200. In other words, the reader antenna 1130 may be arranged to be partly or fully within the reader cavity 1200. The reader cavity 1200 may be an element configured to read qbits and increase the coherence state duration of qbits.

The storage cavity 1300 may fully or partly surround the storage antenna 1140. In other words, the storage antenna 1140 may be arranged to be partly or fully within the storage cavity 1300. A storage cavity 1310 may be an element configured to perform unitary operations using qbits and increase the coherence state duration of qbits.

The reader cavity 1200 and the storage cavity 1300 may be provided in the housing 1010. In some examples, the housing 1010 is a single piece of housing and the reader cavity 1200 and the storage cavity 1300 may be provided therein. In other examples, the housing 1010 may be two housing pieces; the reader cavity 1200 have one a housing and the storage cavity 1300 may have another housing. The housing 1010 may include superconducting materials, such as aluminum (Al), niobium (Nb), indium (In), or combinations thereof.

The housing 1010 may include ports 300. Some of the ports may be openings between the outside of the housing 1010 and the reader cavity 1200. Some of the ports may include openings between the reader cavity 1200 and the storage cavity 1300. The qbit chip 1100 may extend from the outside of the housing 1010 to the storage cavity 1300 through a port between the housing 1010 and the reader cavity 1200, and through a port between the reader cavity 1200 and the storage cavity 1300. The storage connector may be arranged in the storage cavity 1300 through a port between the housing 1010 and the reader cavity 1200, and a port between the reader cavity 1200 and the storage cavity 1300. The reader connector may be arranged in the reader cavity 1200 through a port between the housing 1010 and the reader cavity 1200.

According to the present disclosure, some embodiments may provide quantum computing elements with improved quantum information storage density.

According to the present disclosure, some embodiments may provide a multi-mode resonator having a high quantum information storage density within practical frequency spectrums and a quantum computing element including the same.

Effects of the present disclosure are not limited thereto.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. An apparatus comprising a multi-mode electromagnetic resonator comprising:
a structure configured with a cavity therein that extends lengthwise in a first direction, the cavity comprising a first side surface and a second side surface facing each other;
iris regions at positions along the first direction on the first side surface of the cavity,
wherein the iris regions are arranged to overlap respective electromagnetic fields that form in the cavity in a target mode when electromagnetic energy is supplied to the cavity.

2. The apparatus of claim 1, wherein the iris regions overlap respective centers of the respective electromagnetic fields when electromagnetic energy is supplied to the cavity.

3. The apparatus of claim 1, wherein distances between at least some neighboring iris regions increase in the first direction.

4. The apparatus of claim 1, wherein the first side surface of the cavity has concave structures.

5. The apparatus of claim 1, wherein the first side surface of the cavity has convex parts, and wherein each iris region is arranged, on the first side surface between a corresponding pair of the convex parts.

6. The apparatus of claim 1, wherein the first side surface of the cavity has concave parts, and wherein each iris region is arranged, on the first side surface, between a corresponding pair of the concave parts.

7. The apparatus of claim 1, wherein the cavity has a shape that is a part of a figure determined by
$$x = ( Lc + Loffset ) \times {sin ( t )}^{order} , z = \frac{{w}_{CM}}{2} \times cos ( t ) ,$$
where Lc is less than half the maximum length of the figure on an x-axis as determined by the equation, where Loffset is a length difference between Lc and half the maximum length of the figure on the x-axis, and where W_{CM} is a maximum width of the cavity on a z-axis.

8. The apparatus of claim 1, wherein the iris regions have a same width.

9. The apparatus of claim 1, wherein the structure comprises a housing comprising the cavity and the iris regions, and wherein the cavity and the iris regions are defined by the housing.

10. The apparatus of claim 9, further comprising: a port penetrating the housing and having an opening to the cavity.

11. The apparatus of claim 1, wherein the cavity is a storage cavity, and wherein the multi-mode resonator is the storage cavity and a reader cavity for a quantum computing apparatus.

12. The apparatus of claim 1, wherein the apparatus is a computing apparatus comprising a qbit element, an antenna coupled with the qbit element, and wherein at least a portion of the antenna is within the cavity.

13. A quantum computing apparatus comprising:
a qbit element;
a storage cavity and a reader cavity within a housing or within respective housings;
a storage antenna configured to be electrically connected to the qbit element and at least partly within the storage cavity;
a reader antenna configured to be electrically connected to the qbit element and at least partly within the reader cavity; and
wherein the storage cavity extends lengthwise in a first direction and comprises:
iris regions arranged at positions along the first direction on a first side surface of the storage cavity, and
wherein the positions of the iris regions are arranged to overlap respective electromagnetic fields that form in the storage cavity in a target mode when electromagnetic energy is supplied to the storage cavity.

14. The quantum computing apparatus of claim 13, wherein the iris regions are arranged to overlap respective centers of the electromagnetic fields.

15. The quantum computing apparatus of claim 13, wherein distances between at least some neighboring iris regions increase in the first direction.

16. The quantum computing apparatus of claim 13, wherein a surface of the storage cavity has a concave structure.

17. The quantum computing apparatus of claim 13, wherein the first side surface of the storage cavity has convex parts, and wherein each iris region is positioned between a corresponding pair of the convex parts.

18. The quantum computing apparatus of claim 13, wherein the first side surface of the storage cavity has concave parts, and wherein each iris region is positioned between a corresponding pair of the concave parts.

19. The quantum computing apparatus of claim 13, wherein a width of the storage cavity tapers in the first direction.

20. The quantum computing apparatus of claim 13, wherein the iris regions have a same width.

21. The quantum computing apparatus of claim 13, wherein the iris regions are part of the housing or one of the housings, and wherein the storage cavity and the iris regions are defined by the housing or the one of the housings.

22. The quantum computing apparatus of claim 21, further comprising: a port penetrating the housing or one of the housings and connected to the storage cavity.

23. An apparatus comprising:
a housing comprising a cavity therein, the housing comprising an electromagnetic shielding material;
the cavity comprising a first surface of the housing opposite a second surface of the housing, the first surface having a length, wherein the first surface and the second surface taper in width in a direction along the length; and
the first surface comprising iris structures arranged at positions along the length, wherein the iris structures are perpendicular to the length, and wherein the positions correspond to respective positions of electromagnetic fields that would be induced by electromagnetic resonance in the cavity without the iris structures.
